(19) United States
(12) Patent Application Publication
(10) Pub. No.: US 2024/0104334 A1
(43) Pub. Date: Mar. 28, 2024

(54) ASCERTAINING ONE OR MORE CONNECTION STATES IN FLUID LINE ASSEMBLY

(71) Applicant: Norma U.S. Holding LLC, Auburn Hills, MI (US)

(72) Inventors: Brian Ignaczak, Rochester, MI (US); Thomas Brendler, Grossostheim (DE); Jean-Luc Kirmann, Versailles (FR)

(21) Appl. No.: 18/371,794

(22) Filed: Sep. 22, 2023

Related U.S. Application Data
(60) Provisional application No. 63/409,080, filed on Sep. 22, 2022.

(51) Int. Cl. G06K 19/077; F16L 37/12

(52) U.S. Cl. CPC G06K 19/07775; F16L 37/12; F16L 2201/10; F16L 2201/60

(57) ABSTRACT

A method of ascertaining one or more connection states of fluid line quick connectors in a fluid line assembly is set forth. The method involves assembling the fluid line quick connectors in respective connection locations at the fluid line assembly, and involves furnishing unique identifiers, positional information, or both, of the fluid line quick connectors. The unique identifiers and/or positional information is employed in a determination of whether intended connections have indeed been properly made among the fluid line quick connectors and connection ends of the fluid line assembly. Data matrix scanning, radio-frequency (RF) signaling, or a combination of both technologies can provide the unique identifiers and/or positional information at varying times for the determination.

### CROSS-REFERENCE TO RELATED APPLICATION

This application claims the benefit of U.S. Provisional Patent Application No. 63/409,080, with a filing date of Sep. 22, 2022, the contents of which are hereby incorporated by reference in their entirety.

### TECHNICAL FIELD

This disclosure relates generally to quick connectors and fluid line assemblies, and to ways of determining whether intended connections have been made between quick connectors and fluid line assemblies or other connection information.

### BACKGROUND

Quick connectors are commonly used to join fluid and/or component lines together in a fluid-tight manner. Quick connectors typically exhibit ready connect and disconnect functionality. One example where quick connectors are useful is fluid lines in vehicles. A more specific example is coolant fluid lines for batteries in electric and hybrid vehicle automobiles, and yet another example is hydrogen fluid lines in hydrogen-fuel vehicles. Still, other examples exist in automotive applications, as well as in non-automotive applications like industrial-manufacturing, aerospace, marine, and agricultural applications, to name a few. For initial assembly and inspection and subsequent service, visual measures are often employed in quick connectors in order to verify that a proper connection has been made. These measures typically call for physical interaction and viewing by an assembler, inspector, and servicer to confirm the establishment of the intended connection.

### SUMMARY

In an embodiment, a method of assembling a multitude of fluid line quick connectors in a fluid line assembly may have several steps. One step may involve assembling the multitude of fluid line quick connectors in respective connection locations of the fluid line assembly. Another step may involve obtaining a first set of unique identifiers of the multitude of fluid line quick connectors from each of the fluid line quick connectors. The first unique identifiers identify individual fluid line quick connectors of the multitude of fluid line quick connectors. Yet another step may involve displaying connection information of the multitude of fluid line quick connectors in the fluid line assembly (e.g., presence of fluid line quick connectors at connection locations) based in part or more upon correspondence of the first set of unique identifiers with a second set of unique identifiers and positional information of the multitude of fluid line quick connectors.

In another embodiment, a method of ascertaining one or more connection states of a fluid line assembly may have several steps. One step may involve assembling a multitude of fluid line quick connectors in respective connection locations of the fluid line assembly. Another step may involve obtaining a first set of unique identifiers and a connection state or disconnection state of the multitude of fluid line quick connectors from each of the fluid line quick connectors. The first unique identifiers identify individual fluid line quick connectors of the multitude of fluid line quick connectors. Yet another step may involve determining the connection state(s) of the fluid line assembly based in part or more upon correspondence of the first set of unique identifiers with a second set of unique identifiers and positional information of the multitude of fluid line quick connectors, and based in part or more upon the connection state or disconnection state of each of the multitude of fluid line quick connectors.

In yet another embodiment, a method of ascertaining one or more connection states of a fluid line assembly may have several steps. One step may involve assembling a multitude of fluid line quick connectors in respective connection locations of the fluid line assembly. Another step may involve obtaining a first set of unique identifiers and a connection state or disconnection state of the multitude of fluid line quick connectors from each of the fluid line quick connectors. The first unique identifiers identify individual fluid line quick connectors of the multitude of fluid line quick connectors. Each of the multitude of fluid line quick connectors having a radio-frequency identification (RFID) tag that conveys the first set of unique identifiers and the connection or disconnection state. Yet another step may involve scanning a data matrix in order to obtain a second set of unique identifiers and positional information of the multitude of fluid line quick connectors. And another step may involve determining the connection state(s) of the fluid line assembly based in part or more upon correspondence of the first set of unique identifiers with the second set of unique identifiers and positional information of the multitude of fluid line quick connectors, and based in part or more upon the connection state or disconnection state of each of the multitude of fluid line quick connectors.

### BRIEF DESCRIPTION OF THE DRAWINGS

Embodiments of the disclosure are described with reference to the appended drawings, in which:

FIG. 1 is a depiction of an embodiment of a method of ascertaining one or more connection states of a fluid line assembly;

FIG. 2 is a flow chart of the method of ascertaining the connection state(s) of the fluid line assembly; and

FIG. 3 shows an embodiment of a line map.

### DETAILED DESCRIPTION

Embodiments of a method of ascertaining one or more connection states of fluid line quick connectors (hereafter, “quick connector(s)”) in a fluid line assembly are detailed in this description and depicted in the figures. The method, per an embodiment, employs the use of radio-frequency identification (RFID) technologies that enable determination of a multitude of connections, or lack thereof, via an RFID reader that can be located remote of an immediate site of the connections and at a distance from the fluid line assembly, if suitable. In this way, initial installation, inspection, and subsequent service inspections can be carried out in an automated, robotic, and/or autonomous or semi-autonomous fashion—those often sought in advanced manufacturing facilities for automotive production, for instance. Trouble-shooting connection issues can be more readily and efficiently performed. This description presents the method in the context of vehicle fluid lines—such as battery coolant fluid lines in electric and hybrid vehicle automobiles, and hydrogen fluid lines in hydrogen-fuel vehicle automobiles, among other possibilities—but the method has broader application and may be useful in industrial manufacturing, aircraft, marine, and agricultural applications, as well as others. Still, other applications include those in which the quick connectors are located in inconvenient and inaccessible sites when installed, such as within enclosed structures and closed battery packs, and those in which making the intended connections is of increased criticality.

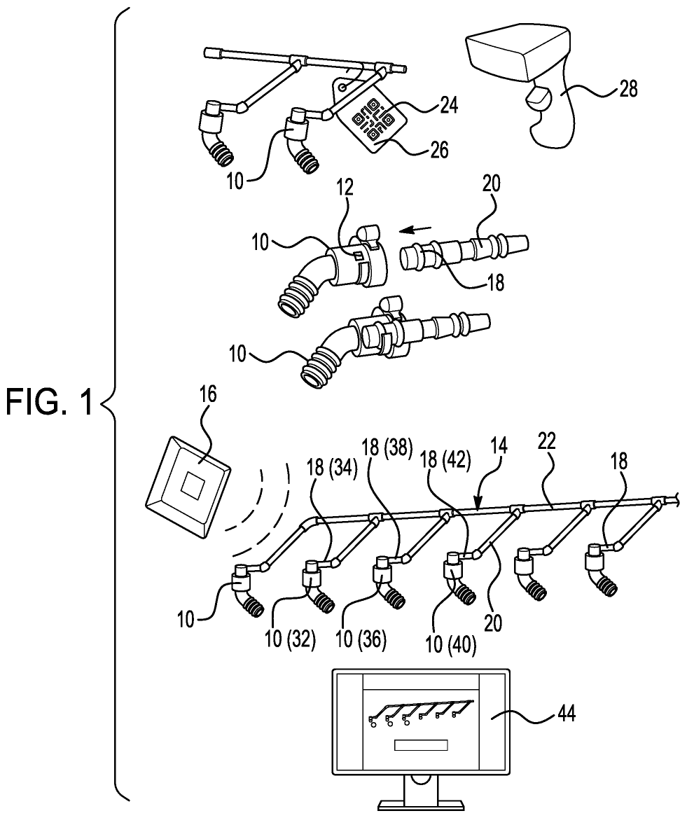

The method can involve various steps and various equipment and components within the steps, depending in some cases upon the particular application of use and upon the constructions of the quick connectors, among other potential factors. Indeed, the method may have more, less, and/or different steps than those presented herein. In the embodiment of the figures, and with reference to FIG. 1, the method employs the use of a multitude of quick connectors 10, each equipped with an RFID tag 12 as part of its construction. The RFID tags 12 are carried by the quick connectors 10. Depending on the embodiment of the quick connectors 10, the RFID tags 12 serve to provide an indication of proper connection and securement being made (i.e., connection state) by the quick connectors 10 upon interrogation, and/or serve to provide an indication that proper connection and securement has not been made (i.e., disconnection state) and is absent. The quick connectors 10 themselves can have various designs, constructions, and components in different embodiments, depending in some cases on the application in which the quick connectors 10 are installed, depending on an associated spigot, hose, and/or tube, and depending on the desired attributes of the connections and joints ultimately established, among other possible factors. Examples of quick connectors that may be suitable for use in the method include those described in U.S. Pat. Nos. 10,975,993; 11,048,994; 11,199,282; and 11,306,857, all under assignee Norma U.S. Holding LLC of Auburn Hills, Michigan, U.S.A.; still, other examples of quick connectors are possible, including those from other companies. The disclosures of U.S. Pat. Nos. 10,975,993; 11,048,994; 11,199,282; and 11,306,857 are hereby incorporated in their entireties herein by reference.

The RFID tags 12 assist in detection of proper connections and securements between the quick connectors 10 and a fluid line assembly 14 or disconnection therebetween. The RFID tags 12 exchange radio frequency (RF) signals with an RFID reader 16 (also called an RFID interrogator). In general, the RFID tags 12 can be of the passive type of tag or the active type of tag. Depending on the type, the RFID tags 12 can be composed of a substrate, an integrated circuit, an antenna, a battery, or a combination thereof, among other components. When interrogated, the RFID tags 12 can convey various data and information to the RFID reader 16. In an embodiment, each of the RFID tags 12 conveys a unique identifier or unique ID. The term “unique identifier” is intended to have an expansive meaning to refer to identifiers, codes, and/or values, as well as other identification indicia. The unique identifier can be used to identify a particular quick connector of the quick connectors 10—for example, quick connector one (QC1), quick connector two (QC2), quick connector three (QC3), etc. Further, in an embodiment, the unique identifier can be used to identify and furnish positional information of the quick connectors 10 with respect to the fluid line assembly 14 and/or with respect to one another—for example, connection location one (L1), connection location two (L2), connection location three (L3), etc. The connection locations can correspond to connection sites and connectors of the fluid line assembly 14. The positional information can be the enumerated positions of individual quick connectors relative to the fluid line assembly 14 and/or relative to other quick connectors. Furthermore, in an embodiment, the RFID tags 12 can also convey a connection state or a disconnection state of the associated individual quick connector 10. That is, the data and information conveyed can be indicative of whether a proper connection is made or, conversely, whether a proper connection is lacking and the associated individual quick connector 10 remains disconnected. In an embodiment, the RFID tags 12 can convey a first set of unique identifiers and positional information.

The RFID reader 16 provides RF signaling to the fluid line assembly 14 and to the quick connectors 10 and RFID tags 12 in order to detect the presence of the RFID tags 12 and receive conveyance therefrom. RFID readers generally have one or more antennas for exchanging RF signaling, as will be appreciated by skilled artisans. The RFID reader 16 can deploy targeted signaling and communications to the RFID tags 12. The RFID reader 16 can issue a query command to initiate the detection procedure, as an example, and can receive signals from the RFID tags 12 in response. The received signals can be processed via a data consumer of the RFID reader 16. The data consumer can be software embedded in the RFID reader 16 or of another component having upstream or downstream communications with the RFID reader 16. In general, the RFID reader 16 can be a fixed device, a portable device, or a handheld device. In a manufacturing facility, for example, the RFID reader 16 can be stationed amid an assembly, inspection, and/or installation production line, and can establish an interrogation zone in which the RFID reader 16 seeks to intercommunicate with the RFID tags 12 as the fluid line assembly 14 and quick connectors 10 are transported through the interrogation zone or temporarily halted thereat, depending on the particular application.

The fluid line assembly 14 can exhibit various designs, constructions, and components according to different embodiments and depending on the particular application. In the embodiment of FIG. 1, multiple counterpart connection ends 18 interconnect with the quick connectors 10. There may be a single connection end 18 for each quick connector 10 in the fluid line assembly 14. Each connection end 18 can constitute a connection location of the fluid line assembly 14. The connection ends 18 are portions of spigots 20 of the fluid line assembly 14. The spigots 20 extend to, and fluidly communicate with, a common manifold 22 of the fluid line assembly 14. The fluid line assembly 14 and its constituent parts can be composed of a plastic material. In the example of FIG. 1, the fluid line assembly 14 is one component of a larger assembly such as a coolant fluid line assembly in a battery pack installation of an electric vehicle automobile.

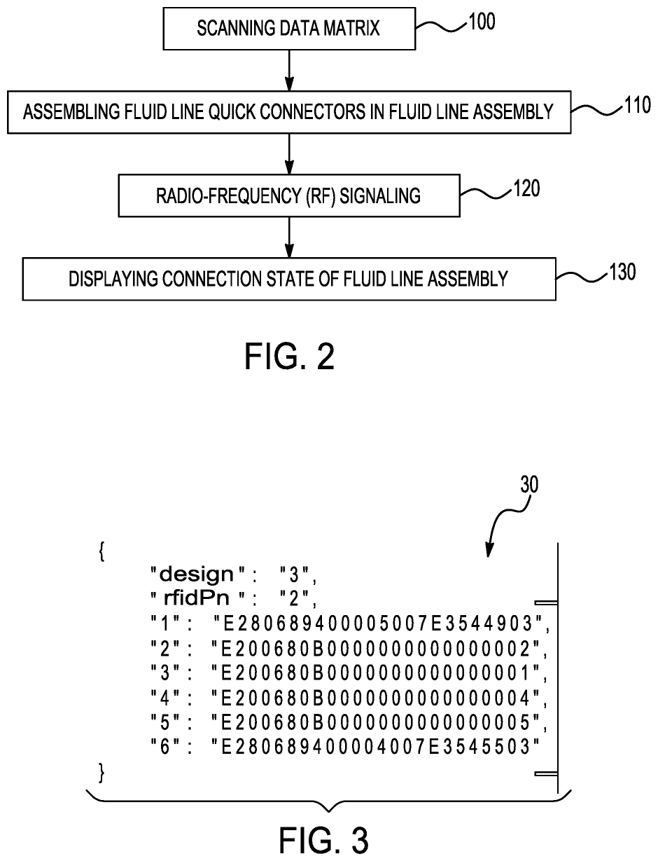

FIG. 2 presents an embodiment of the method of ascertaining the connection state(s) of the quick connectors 10 in the fluid line assembly 14 in a flow chart diagrammatic form. The method has multiple steps and procedures, some of which need not necessarily be executed in certain embodiments. And the steps and procedures need not necessarily be performed in the order and sequence presented. In an alternative embodiment, a method of assembling the quick connectors 10 in the fluid line assembly 14 furnishes connection information such as the presence or absence of the quick connectors 10 at their intended locations in the fluid line assembly 14. In the embodiment of FIG. 2, a step 100 involves scanning a data matrix 24 (FIG. 1) in order to obtain the unique identifier, to obtain the positional information, or to obtain both the unique identifier and positional information of the quick connectors 10 with respect to the fluid line assembly 14. The unique identifier and/or positional information obtained here can be in addition to that provided by the RFID tags 12 upon interrogation, can be in combination with that provided by the RFID tags 12 upon interrogation, or can be in lieu of the provision via the RFID tags 12. Further, the unique identifier and/or positional information obtained here can serve as an expectation, or reference, for the unique identifier, positional information, and/or connection state or disconnection state provided by the RFID tags 12. In an embodiment, the unique identifier and/or positional information obtained via the data matrix 24 is a second set of unique identifiers and positional information.

The data matrix 24 can have various forms in different embodiments. The data matrix 24 can be a two-dimensional machine-readable code consisting of a black and white pattern, for instance. Other examples include quick response (QR) codes, barcodes, shot codes, color codes, visual codes, as well as many others; in this regard, the phrase “data matrix” is used expansively herein to cover all of these forms. Depending on its form, the data matrix 24 can encode information and data with letters and/or digits. The data matrix 24 can be marked on labels or other substrates that are then adhered in place on the fluid line assembly 14, or can be marked directly in place on the fluid line assembly 14 such as by way of printing or laser etching. In the embodiment of FIG. 1, the data matrix 24 resides on a label 26 that is carried by the fluid line assembly 14. The data matrix 24 can be read and scanned by a device, such as a handheld device 28. When obtained via the data matrix 24, the unique identifier and/or positional information can be conveyed as a predefined line map 30 that is stored by the data matrix 24, as depicted in FIG. 3. The predefined line map 30 can take different forms in different embodiments, and in FIG. 3 is a series of strings of identifying letters and digits. From reading and scanning, the predefined line map 30 or other information and data can be conveyed to a controller, computer, or other suitable component, depending on the embodiment. Still, in other embodiments the predefined line map 30 and unique identifier and positional information could be obtained in other ways—and need not involve scanning a data matrix—including by way of storing the predefined line map 30 and information in an accessible database, or by way of conveying the predefined line map 30 and information via a discrete RFID tag subject to interrogation.

With reference again to FIG. 2, a step 110 of the method involves assembling the quick connectors 10 in the fluid line assembly 14. A single quick connector 10 can be connected to a single connection end 18 at a single connection location of the fluid line assembly 14. For example, a first quick connector 32 is connected at a first connection end 34, a second quick connector 36 is connected at a second connection end 38, a third quick connector 40 is connected at a third connection end 42, etc. Further, a step 120 of the method involves providing RF signaling at the fluid line assembly 14. The RF signaling is provided via the RFID reader 16, and can be targeted at the connection ends 18 and at the connection locations of the fluid line assembly 14. In response, the RFID tags 12 of the quick connectors 10 can convey the respective unique identifier and positional information. The conveyed unique identifier and positional information can then be compared to the unique identifier and positional information obtained via the data matrix 24 and via the predefined line map 30, according to this embodiment. A determination is then made as to whether the conveyed unique identifier and positional information agrees with, and corresponds to, the unique identifier and positional information obtained via the data matrix 24 and via the predefined line map 30, per this embodiment. This comparison and determination can be executed by programmed software and a processor on a controller, computer, or other suitable component, or by some other way.

Lastly, according to this embodiment of the method of ascertaining the connection state(s), a step 130 involves displaying the connection state(s) of the quick connectors 10 in the fluid line assembly 14. Displaying the connection state(s) is based on, and the result of, the comparison and determination previously carried out. The display can be viewable by a user and operator, and can be via an output and readout on a computer screen 44 (FIG. 1) or some other human-machine-interface (HMI). The display can be a graphical representation of the fluid line assembly and its quick connectors for ease of comprehension by the user/operator, with a graphical representation of each quick connector and associated connection end, as well as a graphical representation of the connection state(s) (e.g., YES/NO, check mark/X, green/red). The connection state(s) can take different forms in different embodiments. In one embodiment, the connection state(s) ascertained is whether all of the quick connectors 10 are connected to all of the intended and respective connection ends 18 and connection locations of the fluid line assembly 14. Here, if one of the quick connectors 10, such as the second quick connector 36, is disconnected or lacks full connection, the connection state output can be NO or some other negative indicia. Conversely, if all of the quick connectors 10 are connected to all of the intended and respective connection ends 18 and connection locations of the fluid line assembly 14, the connection state output can be YES or some other positive indicia.

In another embodiment, the connection states ascertained are for each individual quick connector 10 of the fluid line assembly 14. Here, if the first quick connector 32 is connected to the first connection end 34, and the second quick connector 36 is connected to the second connection end 38, but the third quick connector 40 is disconnected from the third connection end 42, the connection state output can be YES, YES, NO, or some other indicia, for the respective connections. Knowing the precise location of the disconnection (i.e., third quick connector 40 and third connection end 42) out of the multitude of quick connectors and connection locations otherwise properly connected, per this example, allows a user/operator to more readily trouble-shoot and attend to the lapse for resolution.

Moreover, the inspection of the connection state(s) of the quick connectors 10 furnished by the method may be supplemental to other measures of physical and visual verification exhibited by the quick connectors 10, depending on the particular embodiment.

Still, other embodiments of the method could employ only the use of data matrix technologies, and could hence lack RFID technologies. In such an embodiment, the quick connectors 10 could each be equipped with data matrices 24. And each of the data matrices 24 could convey a unique identifier and/or positional information unique to a particular quick connector of the multitude of quick connectors 10—for example, data matrix one with quick connector one, data matrix two with quick connector two, data matrix three with quick connector three, etc. Further, as in the previous embodiment, the predefined line map 30 can be stored in a discrete data matrix 24, or could be obtained in other ways. The handheld device 28, or another data matrix reader and scanner, can be used to carry out scanning of the quick connectors 10 and their unique data matrices 24. Comparisons can then be made between the scanned unique identifiers and/or positional information of the quick connectors 10 and the unique identifier and/or positional information of the discrete data matrix 24 and predefined line map 30. Further, as before, a determination can then be made as to whether the scanned unique identifier and/or positional information of the quick connectors 10 agrees with, and corresponds to, the unique identifier and/or positional information obtained via the discrete data matrix 24 and via the predefined line map 30, per this embodiment. Yet further, in an embodiment, the data matrices 24 can also convey a connection state or a disconnection state of the associated individual quick connector 10.

As used herein, the terms “general” and “generally” are intended to account for the inherent degree of variance and imprecision that is often attributed to, and often accompanies, any design and manufacturing process, including engineering tolerances—and without deviation from the relevant functionality and outcome—such that mathematical precision and exactitude is not implied and, in some instances, is not possible. In other instances, the terms “general” and “generally” are intended to represent the inherent degree of uncertainty that is often attributed to any quantitative comparison, value, and measurement calculation, or other representation.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A method of assembling a plurality of fluid line quick connectors in a fluid line assembly, the method comprising:
assembling the plurality of fluid line quick connectors in respective connection locations of the fluid line assembly;
obtaining a first set of unique identifiers of the plurality of fluid line quick connectors from each of the plurality of fluid line quick connectors, the first unique identifiers identifying individual fluid line quick connectors of the plurality of fluid line quick connectors; and
displaying connection information of the plurality of fluid line quick connectors in the fluid line assembly based at least on correspondence of the first set of unique identifiers with a second set of unique identifiers and positional information of the plurality of fluid line quick connectors.

2. The method as set forth in claim 1, wherein obtaining the first set of unique identifiers comprises providing each of the plurality of fluid line quick connectors with a radio-frequency (RF) signaling at the connection locations of the fluid line assembly and at the plurality of fluid line quick connectors, each of the plurality of fluid line quick connectors having a radio-frequency identification (RFID) tag conveying the first set of unique identifiers.

3. The method as set forth in claim 1, wherein obtaining the first set of unique identifiers comprises providing each of the plurality of fluid line quick connectors with a data matrix scanning at the connection locations of the fluid line assembly and at the plurality of fluid line quick connectors, each of the plurality of fluid line quick connectors having a data matrix carried thereby conveying the first set of unique identifiers.

4. The method as set forth in claim 1, wherein obtaining the first set of unique identifiers comprises obtaining a connection state or disconnection state of each of the plurality of fluid line quick connectors.

5. The method as set forth in claim 1, further comprising scanning a data matrix in order to obtain the second set of unique identifiers and positional information of the plurality of fluid line quick connectors.

6. The method as set forth in claim 5, wherein the data matrix is carried by the fluid line assembly.

7. The method as set forth in claim 5, wherein scanning the data matrix and obtaining the second set of unique identifiers and positional information is performed prior to obtaining the first set of unique identifiers.

8. The method as set forth in claim 1, further comprising obtaining first positional information, the first positional information providing first connection locations of each of the plurality of fluid line quick connectors.

9. The method as set forth in claim 1, wherein the second unique identifiers identify the individual fluid line quick connectors of the plurality of fluid line quick connectors, and the second positional information provides second connection locations of each of the plurality of fluid line quick connectors.

10. The method as set forth in claim 1, wherein displaying the connection information comprises displaying individual connection states of each of the fluid line quick connectors at each of the respective connection locations of the fluid line assembly.

11. The method as set forth in claim 10, wherein the individual connection states of the fluid line assembly is indicative of whether connections have been made between the plurality of fluid line quick connectors and corresponding connection ends of the fluid line assembly.

12. The method as set forth in claim 1, wherein the connection information comprises presence or absence of the plurality of fluid line quick connectors at the respective connection locations of the fluid line assembly.

13. A method of ascertaining at least one connection state of a fluid line assembly, the method comprising:
assembling a plurality of fluid line quick connectors in respective connection locations of the fluid line assembly;
obtaining a first set of unique identifiers and a connection state or disconnection state of the plurality of fluid line quick connectors from each of the plurality of fluid line quick connectors, the first unique identifiers identifying individual fluid line quick connectors of the plurality of fluid line quick connectors; and
determining the at least one connection state of the fluid line assembly based at least on correspondence of the first set of unique identifiers with a second set of unique identifiers and positional information of the plurality of fluid line quick connectors, and based at least on the connection state or disconnection state of each of the plurality of fluid line quick connectors.

14. The method as set forth in claim 13, further comprising displaying the at least one connection state of the fluid line assembly based at least on correspondence of the first set of unique identifiers with the second set of unique identifiers and positional information of the plurality of fluid line quick connectors, and based at least on the connection state or disconnection state of each of the plurality of fluid line quick connectors.

15. The method as set forth in claim 13, wherein obtaining the first set of unique identifiers and connection or disconnection state comprises providing each of the plurality of fluid line quick connectors with a radio-frequency (RF) signaling at the connection locations of the fluid line assembly and at the plurality of fluid line quick connectors, each of the plurality of fluid line quick connectors having a radio-frequency identification (RFID) tag conveying the first set of unique identifiers and connection or disconnection state.

16. The method as set forth in claim 13, wherein obtaining the first set of unique identifiers and connection or disconnection state comprises providing each of the plurality of fluid line quick connectors with a data matrix scanning at the connection locations of the fluid line assembly and at the plurality of fluid line quick connectors, each of the plurality of fluid line quick connectors having a data matrix carried thereby conveying the first set of unique identifiers and connection or disconnection state.

17. The method as set forth in claim 13, further comprising scanning a data matrix in order to obtain the second set of unique identifiers and positional information of the fluid line quick connectors.

18. A method of ascertaining at least one connection state of a fluid line assembly, the method comprising:
assembling a plurality of fluid line quick connectors in respective connection locations of the fluid line assembly;
obtaining a first set of unique identifiers and a connection state or disconnection state of the plurality of fluid line quick connectors from each of the plurality of fluid line quick connectors, the first unique identifiers identifying individual fluid line quick connectors of the plurality of fluid line quick connectors, each of the plurality of fluid line quick connectors having a radio-frequency identification (RFID) tag conveying the first set of unique identifiers and connection or disconnection state;
scanning a data matrix in order to obtain a second set of unique identifiers and positional information of the fluid line quick connectors; and
determining the at least one connection state of the fluid line assembly based at least on correspondence of the first set of unique identifiers with the second set of unique identifiers and positional information of the plurality of fluid line quick connectors, and based at least on the connection state or disconnection state of each of the plurality of fluid line quick connectors.

19. The method as set forth in claim 18, further comprising displaying the at least one connection state of the fluid line assembly based at least on correspondence of the first set of unique identifiers with the second set of unique identifiers and positional information of the plurality of fluid line quick connectors, and based at least on the connection state or disconnection state of each of the plurality of fluid line quick connectors.
